(19) United States
(12) Patent Application Publication
(10) Pub. No.: US 2005/0015940 A1
(43) Pub. Date: Jan. 27, 2005

(54) Anchoring clamp

(76) Inventor: Jeffrey B. Stafford, Coatesville, PA (US)

Correspondence Address: Eugene E. Renz, Jr., P.C., 205 North Monroe Street, Post Office Box 2056, Media, PA, 19063-9056, US

(21) Appl. No.: 10/612,492

(22) Filed: Jul. 2, 2003

Related U.S. Application Data
(60) Provisional application No. 60/393,535, filed on Jul. 3, 2002.

(51) Int. Cl. F16G 11/06

(52) U.S. Cl. 24/135 N; 24/135 R

(57) ABSTRACT

A clamp assembly for securing a flexible cable comprising an elongated body portion, a bore extending through the body portion, a clamping screw mounted in a sidewall of the body portion mounting a shoe at its inner end which snugly fits in a pocket, said shoe having an arcuate face to snugly embrace the cable and a means to finding a recess in the bore wall located opposite said show whereby rotation of screw in direction to advance the shoe inwardly presses the cable into the recess to firmly lock it in place.

This application claims the benefit of U.S. Provisional Application No. 60/393,535 filed Jul. 2, 2002.

### FIELD OF THE INVENTION

The present invention relates broadly to clamping devices and more specifically a clamp for anchoring small aircraft in a park position on the tarmac.

### BACKGROUND OF THE INVENTION

Clamps of the type to which the present invention relates are not new per se. The prior art clamps have certain disadvantages and draw backs. It has been found that some of them are difficult to position between locked and unlocked attitudes. Other tie-down clamps for aircraft have exhibited a tendency to loosen when wind conditions are severe which is some instances results in damage to the aircraft.

### SUMMARY OF THE INVENTION

With the foregoing in mind, it is an object of the present invention to provide a clamp particularly adapted for securing tie-down lines, securing aircraft to the tarmac in a parked position. The clamp of the present invention is characterized by novel features of construction and arrangement which makes it easy to manipulate and operate the clamp between an open position permitting adjustment of lines and a locked position securing the lines. It has been found that the novel locking arrangement secures the lines firmly in a non-slip fashion which is an important consideration in securing small aircraft at airports. Thus the clamp comprises an elongated body portion which is offset angularly at its upper end and has a bore extending through the body portion which in the present instance is of circular cross-section and generally of a diameter greater than the diameter of a cable or cord which passes through the bore of the clamp. The body portion typically has a hook, in the present which may be formed integrally therewith for attaching the clamp to a suitable fitting such as a hook or ring on an aircraft part, such as a wing. A clamping screw, having a threaded shank which engages an internally threaded boss on the side wall of the body portion of the clamp mounts a shoe having an arcuate face which is generally of the same contour as the cable to provide a large surface to surface contact and better locking capabilities. The bore has a recess confronting the shoe so that the cable is deflected into the recess when the screw moves the shoe to a locking position.

### BRIEF DESCRIPTION OF THE DRAWINGS

These and other objects of the present invention and the various features and details of the operation and construction thereof are hereinafter more fully set forth with reference to the accompanying drawings; wherein

FIG. 1 is an end view of the clamp assembly of the present invention;

FIG. 2 is a view of the opposite end of the clamp assembly of the present invention;

FIG. 3 is a top plan view of the clamp assembly of the present invention;

FIG. 4 is a bottom plan view of the clamp assembly of the present invention;

FIG. 5 is a side view of the clamp assembly of the present invention;

FIG. 6 is a longitudinal, sectional view showing the clamping screw in a retracted position;

FIG. 7 is a longitudinal, sectional view similar to FIG. 6 showing the clamping screw in an extended position clamping the cable and the bore;

FIG. 8 is a transverse, sectional view showing the clamping screw and shoe in a fully retracted position;

FIG. 9 is a similar transverse, sectional view showing the clamping screw and shoe in a fully extended position locking the cable in the recess in the bore of the clamp assembly; and

FIG. 10 is a perspective view of an aircraft showing the clamp securing a line to the tarmac.

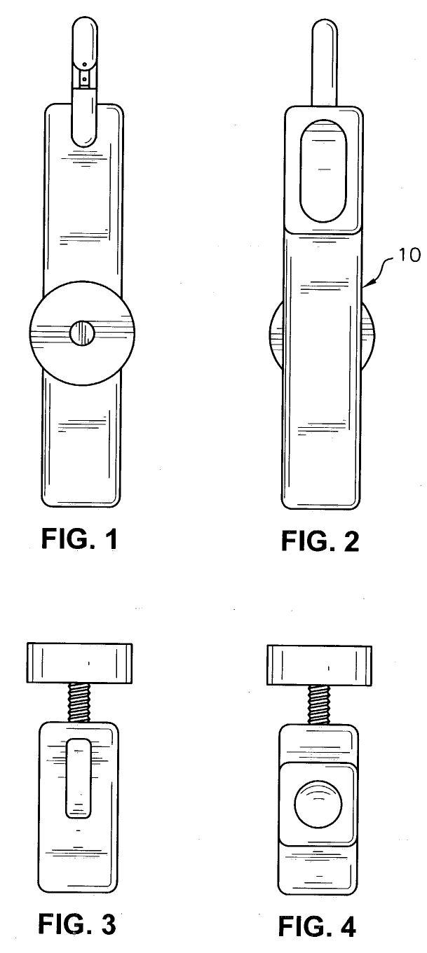

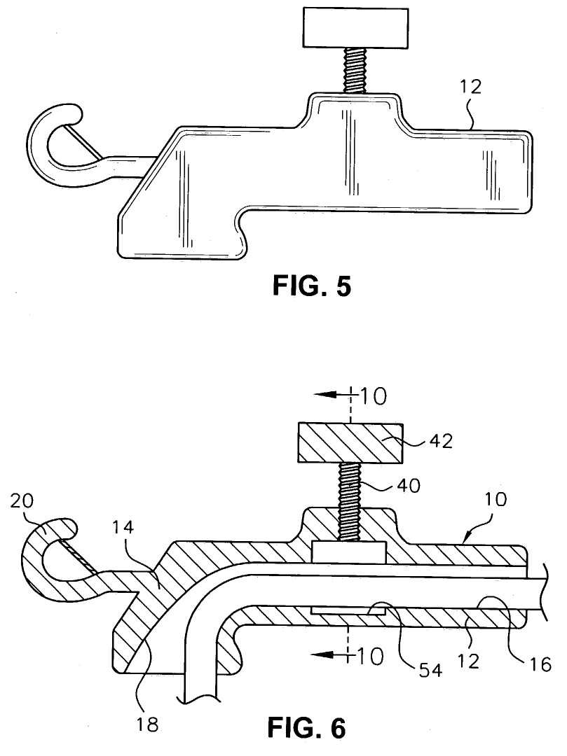

### DETAILED DESCRIPTION OF THE PREFERRED EMBODIMENT

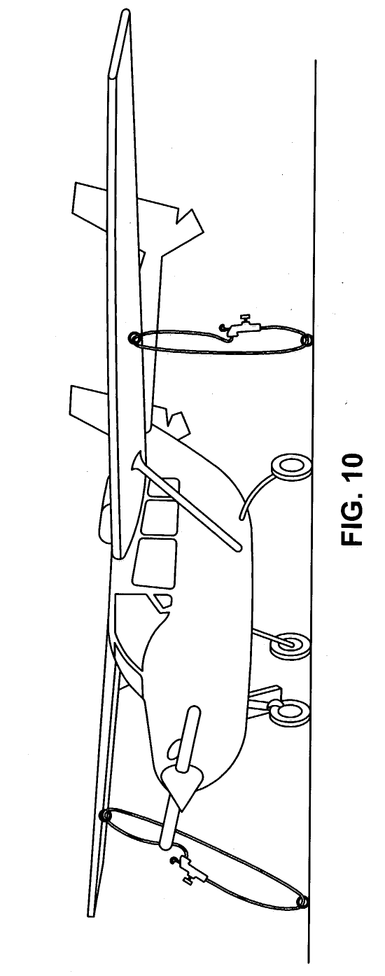

Referring now to the drawings and particularly to FIG. 10 thereof, there is shown a clamp assembly in accordance with the present invention generally designated by the numeral 10. The clamp has many applications and is illustrated herein as the primary means for securing the lines of an aircraft on a tarmac. The clamp of the present invention is easy to manipulate and operate between an open position permitting adjustment of lines and a locked position and by reason of the novel locking arrangement secures the lines firmly which is an important consideration in securing small aircraft at airports. It has been found that high winds tend to buffet the aircraft and loosen lines where they are simply tied by knots or the like as is presently the tie-down procedure

The clamp assembly 10 comprises an elongated body portion 12, in the present instance, of generally square cross section having an offset upper portion as at 14. The body portion 12 has a centrally located bore 16 which is outwardly flared at the upper end as at 18. Cast integrally with the body portion is a hook 20 for removably securing the clamp 10 to a suitable fitting such as a loop or a ring 22 on an aircraft wing.

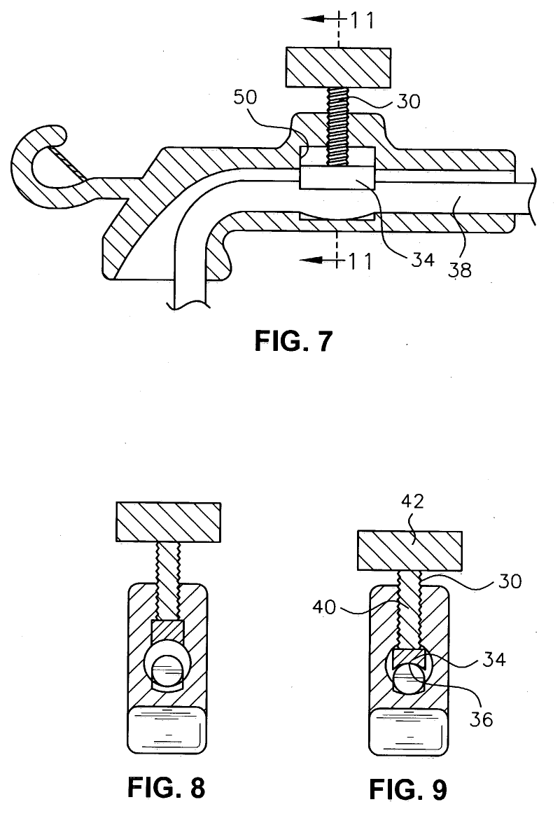

A clamping screw 30 is mounted in the body portion 12 which has a shoe 34 having an arcuate face 36 to conform to the generally rounded or curved shape of a line or rope 38. The shoe is swivelly mounted on a threaded shank 40 of the clamping screw. The screw 30 has a head 42 which can be turned to activate the clamping shoe 34 and clamp a rope or line in the matter shown in FIG. 7. As illustrated in FIGS. 8 and 9, the housing has an internal pocket 50 in which the shoe nests when it is in a fully retracted position. In the present instance, the wall of the rope or line chamber or bore 16 opposite the clamping screw has a relief cut or recess 54 so when it is desired to secure the line firmly in the clamp the line is deflected and pressed into the groove 54 in the manner shown in FIG. 9. It has been found that this arrangement provides for a slip-free holding of the line in the clamp assembly.

Even though a particular embodiment of the present invention has been illustrated and described herein, it is not intended to limit the invention and changes and modifications may be made therein within the scope of the following claims.

1. A clamp assembly for securing a flexible cable comprising an elongated body portion, a bore extending through the body portion, a clamping screw mounted in a sidewall of the body portion mounting a shoe at its inner end which snugly fits in a pocket, said shoe having an arcuate face to snugly embrace the cable and means defining a recess in the bore wall located opposite said shoe whereby rotation of screw in direction to advance the shoe inwardly presses the cable into the recess to firmly lock it in place.

2. A clamp assembly as claimed in claim 1 wherein the bore is offset at its upper end and is flared outwardly in of a gradually increasing diameter greater than the diameter of the central bore section.

3. A clamp assembly as claimed in claim 1 including a hook formed integrally with the body portion for removably securing the clamp assembly to a suitable loop, ball or ring on an aircraft wing.

4. A clamp assembly as claimed in claim 1 wherein the shoe is mounted at the inner terminal end of said threaded shank in a manner to allow rotational movement of the threaded shank without rotating the shoe.
